(19) United States
(12) Patent Application Publication
(10) Pub. No.: US 2026/0296353 A1
(43) Pub. Date: Oct. 1, 2026

(54) SEAT CUSHION AIRBAG DEVICE AND SEAT CUSHION AIRBAG STRUCTURE

(71) Applicant: TOYODA GOSEI CO., LTD., Kiyosu-shi (JP)

(72) Inventors: Masashi HOTTA, Kiyosu-shi (JP); Akihiro NUKAYA, Kiyosu-shi (JP); Shotaro SAIKI, Kiyosu-shi (JP)

(21) Appl. No.: 19/549,077

(22) Filed: Feb. 25, 2026

(30) Foreign Application Priority Data
Mar. 26, 2025 (JP) 2025-052730

(51) Int. Cl. B60R 21/207; B60R 21/00; B60R 21/2338

(52) U.S. Cl. CPC B60R 21/207; B60R 21/2338; B60R 2021/0032; B60R 2021/23386

(57) ABSTRACT

A tether portion 3 of a seat cushion airbag device 1 is fixed to a seat support portion 5 of a seat 90 by a rear side attachment portion 31, and fixed to a front side portion 11f disposed at a front side of an airbag 11 in an expanding and inflating direction, by a front side attachment portion 32. A connection portion 33 between the rear and the front side attachment portions 31 and 32 is attached to the seat support portion 5 and the airbag 11 so as to pass through an airbag attachment portion 15 of the airbag 11. A distance in routing between the airbag attachment portion 15 and the front side attachment portion 32 is increased during expansion and inflation of the airbag 11 as compared with a normal state, and the tether portion 3 is pulled toward the front side attachment portion 32.

### TECHNICAL FIELD

The present disclosure relates to a seat cushion airbag device and a seat cushion airbag structure mounted to a seat of a vehicle.

### BACKGROUND ART

A phenomenon that an occupant seated on a seat of a vehicle is moved forward or downward although the occupant wears a seat belt is known to occur when an impact occurs in the vehicle during collision or the like.

In the present specification, the front side, forward, and the like refer to the front side, forward, and the like in the front-rear direction relative to the body of an occupant seated on a seat portion of a seat. Similarly, the rear side, rearward, and the like refer to the rear side, rearward, and the like in the front-rear direction relative to the body of an occupant seated on a seat portion of a seat. In the present specification, the width direction described below refers to the horizontal direction orthogonal to the front-rear direction, and may also be the left-right direction for the occupant seated on a seat. Furthermore, the upper and the lower refer to the upper in the vertical direction and the lower in the vertical direction, respectively.

For example, a phenomenon (so-called submarine phenomenon) that an occupant slides forward and downward from a seat surface of a seat is known as a kind of the above-described phenomenon.

The submarine phenomenon is considered to be caused since the waist portion of an occupant is moved forward and slides under a waist strap (also referred to as waist belt or lap strap), of the seat belt, for restraining the waist portion of the occupant when an impact is applied to the vehicle from the front side.

In order to inhibit the phenomenon that the occupant is moved, a technique for providing an airbag called a seat cushion airbag under a seat surface of a seat, more specifically, inside a seat portion, is suggested (for example, see JP2018-188123 (A)).

For example, in the technique described in JP2018-188123 (A) the seat surface of the seat is moved upward by expanding and inflating the seat cushion airbag when an impact occurs. JP2018-188123(A) indicates, in paragraph [0007] and the like, that the seat cushion airbag lifts the thigh of the occupant, and thus inhibits forward movement of the occupant.

### SUMMARY

### Technical Problem

As described above, the seat cushion airbag described in JP2018-188123(A) expands and inflates when an impact occurs. The seat cushion airbag moves the waist portion of the occupant upward from below the waist portion during the expansion and inflation. As a result, the forward movement of the occupant is inhibited, so that the above-described submarine phenomenon is considered to be unlikely to occur.

An occupant is seated on the seat cushion airbag and the seat portion, and a downward load acts on the seat portion from the occupant. Therefore, the seat portion is unlikely to be deformed upward since the upward deformation is hindered by the occupant immediately after the seat cushion airbag expands and inflates.

That is, the seat portion is firstly deformed downward since the seat portion is easily deformed downward immediately after the seat cushion airbag expands and inflates, and is thereafter deformed upward. Therefore, a high downward force acts on the seat portion of the seat when the seat cushion airbag expands and inflates.

In order to stably restrain and support an occupant by a seat belt when an impact occurs, the waist portion of the occupant seated on the seat is preferably moved upward greatly, and therefore, the seat cushion airbag needs to greatly expand and inflate in the up-down direction.

Meanwhile, in a case where the seat cushion airbag greatly expands and inflates in the up-down direction, a downward force acting on the seat portion of the seat from the seat cushion airbag also becomes high.

A seat generally has a seat support portion as a structure for supporting a seat portion of the seat. The seat portion of the seat is a portion on which an occupant is seated, and includes a cushion portion, a skin portion covering the cushion portion, and the like in general. Meanwhile, the seat support portion is disposed below the surface of the seat portion in the seat, and is considered to support the seat portion and an occupant seated on the seat portion, from the lower side.

The seat support portion of the seat is pressed downward by the seat cushion airbag that expands and inflates and is deformed downward. Therefore, in a case where the expanding and inflating force of the seat cushion airbag is set to be high in order to greatly move upward the waist portion of an occupant seated on the seat when an impact occurs, the seat support portion is greatly pressed downward by the seat cushion airbag when an impact occurs. At this time, the seat support portion may be deformed depending on cases.

JP2012-106617(A) suggests a technique for extending a seat pan as a part of the seat support portion in the seat front-rear direction and bridging the seat pan over seat bars constituting another part of the seat support portion.

In the technique described in JP2012-106617 (A), a large seat pan extending in the seat front-rear direction comes into contact with the seat cushion airbag over a large area from the lower side during expansion and inflation. Therefore, the seat pan receives an external force caused by the expansion and inflation of the seat cushion airbag, in a dispersed manner, and a reaction force due to the external force is generated in a dispersed manner. Thus, the seat pan supports the seat cushion airbag from the lower side while inhibiting deformation of the entirety of the seat support portion, and may allow the seat cushion airbag to greatly expand and inflate in the upward direction.

In a case where, as described in JP2012-106617(A), the seat pan is enlarged, and the seat pan is extended in the seat front-rear direction, the seat pan is positioned below the buttock of an occupant.

The seat pan is formed of a material having a high stiffness in order to support the seat portion of the seat from the lower side. Therefore, in a case where a large seat pan is extended in the seat front-rear direction, and the seat pan is positioned below the buttock of an occupant, a cushioning property of the seat may be degraded, and seating comfort provided by the seat may be significantly degraded.

The present disclosure has been made in view of the aforementioned circumstances, and an object of the present disclosure is to provide a seat cushion airbag device that supports a seat cushion airbag from the lower side during expansion and inflation, and allows a seat to maintain good seating comfort.

### Solution to Problem

A seat cushion airbag device of the present disclosure for solving the aforementioned problem includes:
a seat cushion airbag disposed below a seat surface in a seat of a vehicle and above a seat support portion for the seat, the seat cushion airbag attached to the seat support portion at an airbag attachment portion, the seat cushion airbag expanding and inflating when an impact occurs in the vehicle; and
a tether portion formed of fabric, the tether portion having a rear side attachment portion disposed on one end side in a longitudinal direction and a front side attachment portion disposed on another end side in the longitudinal direction, at least a part of the tether portion forming a lower side support portion disposed below the seat cushion airbag, in which
the tether portion is
   fixed to the seat support portion by the rear side attachment portion, and
   fixed to a front side portion disposed at a front side of the seat cushion airbag in an expanding and inflating direction, by the front side attachment portion,
a connection portion between the rear side attachment portion and the front side attachment portion is attached to the seat support portion and the seat cushion airbag so as to pass through the airbag attachment portion, and
a distance in routing between the airbag attachment portion and the front side attachment portion is increased during expansion and inflation in which the seat cushion airbag expands and inflates as compared with a distance in a normal state in which the seat cushion airbag does not expand, and the tether portion is pulled toward the front side attachment portion.

A seat cushion airbag structure of the present disclosure for solving the aforementioned problem includes:
a seat support portion disposed below a seat surface in a seat of a vehicle;
a seat cushion airbag disposed below the seat surface and above the seat support portion, the seat cushion airbag attached to the seat support portion at an airbag attachment portion, the seat cushion airbag expanding and inflating when an impact occurs in the vehicle; and
a tether portion formed of fabric, the tether portion having a rear side attachment portion disposed on one end side in a longitudinal direction and a front side attachment portion disposed on another end side in the longitudinal direction, at least a part of the tether portion forming a lower side support portion disposed below the seat cushion airbag, in which
the tether portion is
   fixed to the seat support portion by the rear side attachment portion, and
   fixed to a front side portion disposed at a front side of the seat cushion airbag in an expanding and inflating direction, by the front side attachment portion,
a connection portion between the rear side attachment portion and the front side attachment portion is attached to the seat support portion and the seat cushion airbag so as to pass through the airbag attachment portion, and
a distance in routing between the airbag attachment portion and the front side attachment portion is increased during expansion and inflation in which the seat cushion airbag expands and inflates as compared with a distance in a normal state in which the seat cushion airbag does not expand, and the tether portion is pulled toward the front side attachment portion.

The technique of the present disclosure provides a seat cushion airbag device that supports a seat cushion airbag from the lower side during expansion and inflation, and allows a seat to maintain good seating comfort.

### BRIEF DESCRIPTION OF DRAWINGS

FIG. 1 is a diagram schematically illustrating a seat cushion airbag structure of Example 1 as viewed from the upper side;

FIG. 2 is a diagram schematically illustrating the seat cushion airbag structure of Example 1 in a normal state;

FIG. 3 is an enlarged view of a main portion in FIG. 2;

FIG. 4 is a diagram schematically illustrating the seat cushion airbag structure of Example 1 during expansion and inflation;

FIG. 5 is an enlarged view of a main portion in FIG. 4;

FIG. 6 is a diagram schematically illustrating an airbag of the seat cushion airbag structure of Example 1 in a normal state as viewed from the upper side;

FIG. 7 is a perspective view schematically illustrating the expanded and inflated airbag of the seat cushion airbag structure of Example 1;

FIG. 8 is a diagram schematically illustrating a seat cushion airbag structure of Example 2; and

FIG. 9 is a diagram schematically illustrating a seat cushion airbag structure of Example 3.

### DESCRIPTION OF EMBODIMENTS

A seat cushion airbag device of the present disclosure is disposed below a seat surface in a seat of a vehicle and above a seat support portion for the seat, and includes a seat cushion airbag and a tether portion.

Meanwhile, a seat cushion airbag structure of the present disclosure has the above-described seat support portion as a constituent component in addition to the seat cushion airbag device of the present disclosure.

In the present specification, the seat support portion refers to a portion which is disposed below the surface of a seat portion in the seat and supports the seat portion and an occupant seated on the seat portion from the lower side as described above, and is also a generic term for a rigid body disposed below at least a part of a cushion portion. The seat support portion includes a seat pan, a seat bar (also referred to as shaft), and a seat frame including a side frame.

Hereinafter, in a case where “of the present disclosure”, “in the present disclosure”, or the like is referred to without any explanation, the seat cushion airbag structure of the present disclosure and the seat cushion airbag device of the present disclosure are generically referred to.

The seat cushion airbag device of the present disclosure includes: a seat cushion airbag disposed below a seat surface in a seat of a vehicle and above the seat support portion for the seat, the seat cushion airbag attached to the seat support portion at an airbag attachment portion, the seat cushion airbag expanding and inflating when an impact occurs in the vehicle; and a tether portion formed of fabric, the tether portion having a rear side attachment portion disposed on one end side in a longitudinal direction and a front side attachment portion disposed on another end side in the longitudinal direction, at least a part of the tether portion forming a lower side support portion disposed below the seat cushion airbag.

In the seat cushion airbag device and the seat cushion airbag structure according to the present disclosure as described above, the tether portion is fixed to the seat support portion by the rear side attachment portion, and fixed to a front side portion disposed at a front side of the seat cushion airbag in an expanding and inflating direction, by the front side attachment portion, a connection portion between the rear side attachment portion and the front side attachment portion is attached to the seat support portion and the seat cushion airbag so as to pass through the airbag attachment portion, and a distance in routing between the airbag attachment portion and the front side attachment portion is increased during expansion and inflation in which the seat cushion airbag expands and inflates as compared with a distance in a normal state in which the seat cushion airbag does not expand, and the tether portion is pulled toward the front side attachment portion.

That is, in the seat cushion airbag device and the seat cushion airbag structure according to the present disclosure, the distance in routing between the airbag attachment portion and the front side attachment portion is increased during expansion and inflation as compared with the distance in a normal state, and the tether portion is thus pulled toward the front side attachment portion during expansion and inflation, so that tension is applied to the tether portion.

In the present specification, the distance in routing refers to an actual length from a portion closest to the airbag attachment portion to the front side attachment portion in the tether portion, and, in other words, the distance in routing may refer to a route on the tether portion from the airbag attachment portion to the front side attachment portion.

As described above, the lower side support portion that is at least a part of the tether portion is disposed below the seat cushion airbag.

In the tether portion to which tension is applied, a reaction force due to an external force generated by the seat cushion airbag is generated during expansion and inflation. Thus, the tether portion stably supports the seat cushion airbag from the lower side during expansion and inflation.

In addition, the tether portion is formed of fabric, and is thus bendable and deformable. Therefore, when an occupant is seated on the seat, and the seat portion including a cushion and a skin in the seat is deformed downward, the tether portion below the seat surface in the seat is bent and deformed downward.

Therefore, in the seat cushion airbag device and the seat cushion airbag structure according to the present disclosure, the cushioning property of the seat is unlikely to be degraded, and the seat is allowed to maintain good seating comfort.

The above-described seat cushion airbag device and seat cushion airbag structure according to the present disclosure allow the seat cushion airbag to be supported from the lower side during expansion and inflation and allow the seat to maintain good seating comfort through the above-described cooperation.

The seat cushion airbag device and the seat cushion airbag structure according to the present disclosure will be described below for each constituent component.

As described above, the seat cushion airbag structure of the present disclosure includes the seat cushion airbag device of the present disclosure. Therefore, unless otherwise specified, in the present specification, description for each component of the seat cushion airbag device in the seat cushion airbag structure of the present disclosure may be read as description for each component of the seat cushion airbag device of the present disclosure.

Unless otherwise specified, a numerical value range “x to y” described in the present specification includes a lower limit x and an upper limit y in the range. A new numerical value range may be formed by optionally combining the upper limit value, the lower limit value, and numerical values described in the examples. Numerical values optionally selected from any of the above-described numerical value ranges may be used as the upper and lower limit values in a new numerical value range.

The seat cushion airbag structure and the seat cushion airbag device according to the present disclosure includes the seat cushion airbag and the tether portion.

The seat cushion airbag of the present disclosure is disposed below the seat surface in the seat of a vehicle and above the seat support portion for the seat.

As described above, the seat support portion supports the seat portion in the seat. The seat includes the seat portion on which an occupant is seated, the seat support portion for supporting the seat portion from the lower side, a backrest disposed behind the seat portion in order to support the back of an occupant, an armrest disposed at the end of the seat portion in the width direction, and the like.

In the present specification, the seat may be any seat on which an occupant is seated, and, for example, may be a front seat such as a driver's seat or a passenger seat, or a rear seat.

The seat portion includes a cushion portion, and a skin portion exposed on the surface side of the cushion portion. The seat surface of the seat is formed of the skin portion of the seat portion.

The seat cushion airbag expands and inflates when an impact occurs in a vehicle, and thus lifts the seat surface in the seat, and consequently moves upward the waist portion of an occupant seated on the seat. Thus, the seat cushion airbag structure of the present disclosure including the seat cushion airbag inhibits the above-described submarine phenomenon. Furthermore, advantageously, the seat cushion airbag moves the waist portion of the occupant upward and consequently moves the upper body of the occupant upward, so that a shoulder strap, in a seat belt, for restraining the chest of the occupant stably supports the chest of the occupant.

The seat cushion airbag generally has a bag-like shape in order to expand and inflate when an impact occurs. The seat cushion airbag device has an inflation fluid generation source connected to the seat cushion airbag for supplying an inflation fluid to the seat cushion airbag. Hereinafter, unless otherwise specified, the airbag in the present specification refers to an airbag of the seat cushion airbag device.

The airbag deforms itself during expansion and inflation, and presses upward the seat surface of the seat portion in the seat.

The airbag having such a configuration is preferably stored in the seat portion in a folded or collapsed state in a normal state, and a foldable and expandable material is preferably selected as the material of the airbag.

Specifically, a flexible material having high strength is preferably selected as the material of the airbag, and, for example, woven fabric in which high-strength resin fiber such as polyester and polyamide is used is particularly preferably used.

As the inflation fluid generation source, a so-called inflator for generating gas as an inflation fluid is preferably used. However, a source for generating an inflation fluid such as a liquid or a gel other than gas, may be used depending on cases.

The inflation fluid generation source may be a device for supplying the inflation fluid to the airbag, and may be, for example, a so-called pyro-type inflator that has a gas generating agent for generating gas as the inflation fluid. Alternatively, the inflation fluid generation source may be a so-called hybrid-type inflator for supplying gas stored in a high-pressure vessel by rupturing a separation wall of the high-pressure vessel. The entirety of the inflation fluid generation source may be disposed outside the airbag, or a part or the entirety of the inflation fluid generation source may be disposed inside the airbag.

The airbag is fixed to the seat support portion at the airbag attachment portion. In other words, the airbag attachment portion is a portion of the airbag and is attached to the seat support portion. For example, the airbag attachment portion includes a through hole formed in the airbag, and an attachment tool such as a bolt or a clip which is inserted through the through hole and is fixed to the seat support portion. Alternatively, the airbag attachment portion may be an attachment tool that is integrated with another portion of the airbag.

The shape of the airbag is not particularly limited. However, the airbag preferably has a standing wall extending in the up-down direction in a rear side region at the side portion of the airbag, as specifically described below in examples. The airbag having such a shape effectively moves the waist portion of an occupant upward during expansion and inflation.

Furthermore, in this case, in order to more effectively move the waist portion of an occupant upward during expansion and inflation, the standing wall is more preferably disposed near the ischium of the occupant seated on the seat. Specifically, the standing wall is preferably disposed in the center region that is the center portion of three portions into which the seat portion of the seat is equally divided in the front-rear direction.

A method for attaching the airbag to the seat support portion at the airbag attachment portion is not particularly limited as long as the airbag is stably fixed to the seat support portion in a normal state and during occurrence of an impact.

In the present disclosure, the seat support portion to which the airbag is attached is not particularly limited, and examples of the seat support portion include a seat pan, a seat bar, and a seat frame including a side frame as described above.

The tether portion in the present disclosure is a long member having a tether portion formed of fabric. At least a part of the tether portion is disposed below the airbag. A portion of the tether portion below the airbag is referred to as lower side support portion. Therefore, merely a part of the tether portion may be the lower side support portion, or the entirety of the tether portion may be the lower side support portion.

A portion of the tether portion on one end side in the longitudinal direction is referred to as rear side attachment portion, and a portion of the tether portion on the other end side in the longitudinal direction is referred to as front side attachment portion.

The tether portion is formed of fabric, that is, woven fabric. The method for weaving the fabric is not particularly limited. The material of the tether portion is properly selected as appropriate according to strength required for the tether portion. Specific examples of the material of the tether portion include, but are not limited to, high-strength resin fiber similar to the material of the airbag, glass fiber, carbon fiber, metal fiber, and natural fiber derived from plants or the like.

The tether portion is required to exhibit performance of sufficiently bending and deforming in the up-down direction, and sufficiently supporting the airbag from the lower side during expansion and inflation. The tether portion having such a configuration is more preferably flexible and unlikely to deform by stretching.

The tether portion in the present disclosure is formed of fabric, and is thus unlikely to deform by stretching as compared with, for example, a tether portion formed of knitted or nonwoven fabric. Therefore, the tether portion of the seat cushion airbag structure of the present disclosure is considered to sufficiently bend and deform in the up-down direction and sufficiently support the airbag from the lower side during expansion and inflation.

In other words, the tether portion of the seat cushion airbag structure of the present disclosure is formed of fabric, and thus exhibits an effect of allowing the seat to maintain good seating comfort while the tether portion stably supports the airbag from the lower side during expansion and inflation.

In order to stably support the airbag from the lower side during expansion and inflation, the lower side support portion of the tether portion preferably comes into contact with the airbag over a large area during at least expansion and inflation.

Considering the above-described matter, a suitable range is considered to be set for a relationship between the length of the airbag during expansion and inflation, and the length of the lower side support portion of the tether portion during the expansion and inflation.

Hereinafter, a direction in which the airbag expands and inflates is referred to as expanding and inflating direction as necessary. The length of the airbag in the expanding and inflating direction during expansion and inflation is referred to as expansion and inflation length of the airbag as necessary. Furthermore, the length of the lower side support portion in the expanding and inflating direction of the airbag during expansion and inflation of the airbag is referred to as expansion and inflation length of the lower side support portion as necessary.

The expansion and inflation length of the lower side support portion of the tether portion is preferably one-third or more of the length of the airbag in the expanding and inflating direction, one-half or more thereof, or two-thirds or more thereof. In other words, the lower side support portion preferably overlaps continuously with the airbag over one-third or more of the length of the airbag in the expanding and inflating direction, one-half or more thereof, or two-thirds or more thereof during expansion and inflation.

As described above, since the lower side support portion comes into contact with the airbag over a large area during expansion and inflation, an external force generated by the airbag during expansion and inflation is received by the tether portion in a dispersed manner, and a reaction force generated at this time is sufficiently dispersed. Therefore, an external force generated by the airbag during expansion and inflation does not act on a part of the seat in an unbalanced manner, and, for example, a malfunction that, for example, the seat support portion for the seat is deformed is inhibited.

The length of the tether portion in the width direction is not particularly limited. However, in order to stably support the airbag from the lower side during expansion and inflation, the length of the tether portion in the width direction is preferably 30% or more of the length of the seat portion in the width direction, 50% or more thereof, or 70% or more thereof, or equal to or more than the width of the airbag.

Advantageously, in a case where the tether portion is disposed above a seat spring in the seat portion, a reaction force is efficiently generated by the tether portion through expansion and inflation of the airbag.

The seat spring is a member forming a part of the seat portion, and is disposed below a cushion. In a case where the seat spring is disposed between the cushion and the seat frame, vibration or the like caused by a running vehicle is reduced. Thus, the seat is allowed to enhance ride comfort.

When a downward load acts on the seat spring, the seat spring is elastically compressed downward. Therefore, in a case where the seat spring is disposed just below the airbag, when the airbag expands and inflates downward and presses the seat spring downward during occurrence of an impact, the seat spring is compressed and an external force acting downward from the airbag is reduced. Therefore, a reaction force acting on the airbag from below the airbag during expansion and inflation becomes low depending on the spring characteristic of the seat spring, and the position of the lower end portion of the airbag is lowered. As a result, the airbag is unlikely to quickly expand and inflate upward, so that the seat surface of the seat is unlikely to be quickly moved upward.

In a case where the tether portion is disposed above the seat spring in the seat portion, the tether portion is disposed between the airbag and the seat spring. As described above, by receiving an external force generated when the airbag expands and inflates, a reaction force is generated by the tether portion. Therefore, in this case, an external force generated by the airbag during expansion and inflation is unlikely to be transmitted to the seat spring. Therefore, in this case, the airbag quickly expands and inflates upward, so that the seat surface of the seat is quickly moved upward.

As described above, the tether portion has the rear side attachment portion disposed on one end side in the longitudinal direction and the front side attachment portion disposed on another end side in the longitudinal direction.

The tether portion is fixed to the seat support portion by the rear side attachment portion, and fixed to a front side portion of the airbag, that is, to a portion disposed at a front side of the airbag in the expanding and inflating direction, by the front side attachment portion.

Furthermore, the connection portion of the tether portion between the rear side attachment portion and the front side attachment portion is attached to the airbag so as to pass through the airbag attachment portion.

Therefore, the tether portion is considered to be fixed or held directly or indirectly with respect to the seat support portion by the rear side attachment portion and the front side attachment portion, and, depending on cases, by the connection portion.

A high force acts on the tether portion when the airbag expands and inflates. In order to effectively inhibit the tether portion from deforming by stretching, the tether portion is preferably made unlikely to deform by stretching between the fixing positions, that is, among the rear side attachment portion, the connection portion, and the front side attachment portion, in other words, in the longitudinal direction.

The fabric as the material of the tether portion greatly deforms by stretching in the case of the fabric being bias grain, and is unlikely to deform by stretching in the case of the fabric being lengthwise grain and in the case of the fabric being crosswise grain, and is particularly unlikely to deform by stretching in the case of the fabric being lengthwise grain.

The lengthwise grain described herein refers to fabric in which the direction in which the warp thread extends coincides with the direction in which a force acting on the fabric is highest. Specifically, the lengthwise grain refers to fabric in which the direction in which the warp thread extends in the tether portion coincides with the direction in which the tether portion is extended.

The crosswise grain refers to fabric in which the direction in which the warp thread extends is orthogonal to the direction in which a force acting on the fabric is highest. Specifically, the crosswise grain refers to fabric in which the direction in which the warp thread extends in the tether portion is orthogonal to the direction in which the tether portion is extended.

The bias grain refers to fabric in which the direction in which the warp thread extends intersects the direction in which a force acting on the fabric is highest, at 45°. Specifically, the bias grain refers to fabric in which the direction in which the warp thread extends in the tether portion intersects the direction in which the tether portion is extended, at 45°.

Considering the above-described matter, in order to further inhibit the tether portion from deforming by stretching, an angle between the longitudinal direction of the tether portion and the direction in which the warp thread extends in the tether portion is considered to be preferably 0° or 90°, and particularly preferably 0°.

The angle between the longitudinal direction of the tether portion and the direction in which the warp thread extends in the tether portion may not be strictly 0° or 90°, and may be in a range of 0° or 90°±about 10°.

As described above, the tether portion in the present disclosure is fixed or held directly or indirectly with respect to the seat support portion by the rear side attachment portion and the front side attachment portion, and, depending on cases, by the connection portion. Therefore, the tether portion is considered to be fixed or held directly or indirectly with respect to the seat support portion in the longitudinal direction, and be extended on the seat support portion.

The tether portion may be fixed or held directly or indirectly with respect to the seat support portion at one point of each of the rear side attachment portion and the front side attachment portion, and the connection portion depending on cases. Alternatively, the tether portion may be fixed or held directly or indirectly with respect to the seat support portion at a plurality of points at least at one of the rear side attachment portion and the front side attachment portion, and the connection portion depending on cases.

For example, the rear side attachment portion of the tether portion may be fixed at two points with respect to the seat support portion. In this case, the two points may be aligned along the longitudinal direction, or may be aligned in the direction intersecting the longitudinal direction. In a case where the two points are aligned in the width direction intersecting the longitudinal direction, the tether portion is considered to be fixed or held directly or indirectly with respect to the seat support portion in the longitudinal direction and the width direction, and be extended on the seat support portion.

The same applies to the front side attachment portion and the connection portion.

In the tether portion in the present disclosure, the rear side attachment portion is fixed to the seat support portion, and the front side attachment portion is fixed to the front side portion of the airbag. The connection portion of the tether portion between the rear side attachment portion and the front side attachment portion is attached to the seat support portion and the airbag so as to pass through the airbag attachment portion.

That is, as long as the connection portion in the tether portion passes through the airbag attachment portion in the airbag, the connection portion may be fixed or may not be fixed to the airbag attachment portion.

As an example in which the connection portion is not fixed to the airbag attachment portion, the following aspect (1) and aspect (2) are indicated.

### Aspect (1)

A long hole penetrating through the tether portion in the thickness direction and extending in the longitudinal direction is formed in the connection portion, and the attachment tool of the airbag attachment portion is inserted though the long hole and attached to the seat support portion.

### Aspect (2)

A through hole is formed in the airbag so as to penetrate through the airbag from one of outer surfaces to the other of the outer surfaces, and the connection portion of the tether portion is inserted through the through hole.

In Aspect (1), while the connection portion of the tether portion is held by the airbag attachment portion, the position of the connection portion is changeable relative to the airbag attachment portion.

In Aspect (2), the connection portion of the tether portion is not held by the airbag attachment portion, and is disposed at a position different from the position of the airbag attachment portion in the up-down direction, and is extended through the airbag attachment portion from the rear side to the front side (or from the front side to the rear side) in the expanding and inflating direction.

The tether portion may be folded back with respect to the airbag.

For example, the rear side attachment portion of the tether portion is fixed to the seat support portion below the airbag on the front side in the expanding and inflating direction, and the front side attachment portion of the tether portion is fixed to the front side portion of the airbag on the upper side of the airbag on the front side in the expanding and inflating direction. In this case, the airbag is inserted into the tether portion between the upper side and the lower side of the tether portion with the connection portion being a boundary, so as to be sandwiched therebetween. Furthermore, in this case, preferably, the connection portion is not fixed to the airbag attachment portion as in the above-described Aspect (1) or (2).

In the present disclosure, the tether portion is pulled by the expanded and inflated airbag, and tension is thus applied to the tether portion. Therefore, in a normal state in which the airbag is not expanded and inflated, the tether portion needs to have an extension allowance for a state in which the tether portion is pulled. Therefore, in the present disclosure, at least a part of a region in the tether portion between the rear side attachment portion and the front side attachment portion is preferably bent or folded in the normal state.

The seat support portion is a member disposed below at least a part of the cushion portion in the seat in order to support the cushion portion and an occupant seated on the cushion portion from the lower side, and specific examples of the seat support portion include a seat pan, a seat bar, and a side frame for the seat.

Among them, the seat pan is a plate-shaped member. In general, the seat pan is extended in the front-rear direction and the width direction with respect to the seat portion according to the shape of the seat pan, and the seat pan is thus extended on the seat frame of the seat in the front-rear direction and the width direction. Thus, the seat pan supports the seat portion of the seat from the lower side, and consequently supports the seat portion and an occupant seated on the seat portion from the lower side.

The seat bar is a bar-shaped member, and is extended in the width direction with respect to the seat portion of the seat, more specifically, extended on the seat frame in the width direction, and thus supports the seat portion of the seat from the lower side, and consequently supports the seat portion and an occupant seated on the seat portion from the lower side. In general, the seat bar is disposed rearward of the seat pan, but may be disposed forward of the seat pan.

In the present disclosure, the rear side attachment portion of the tether portion may be fixed to any of the various seat support portions, or may be fixed to two or more of the various seat support portions.

Similarly, the airbag attachment portion of the airbag may be fixed to any of the various seat support portions, or may be fixed to two or more of the various seat support portions. Furthermore, the rear side attachment portion of the tether portion and the airbag attachment portion of the airbag may be fixed to the same seat support portion, or may be fixed to different seat support portions, respectively.

The seat cushion airbag structure and the seat cushion airbag device according to the present disclosure will be described below by using specific examples.

### Example 1

A seat cushion airbag structure of Example 1 includes a seat pan and a seat bar as the seat support portion.

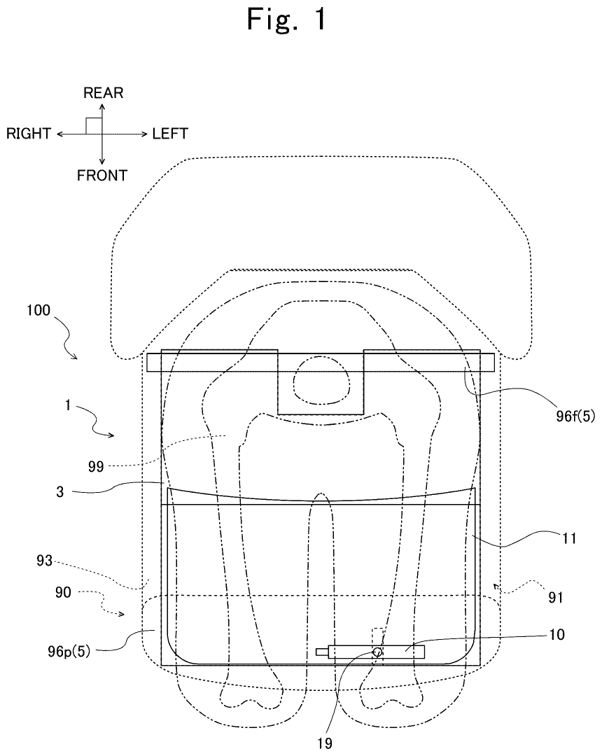

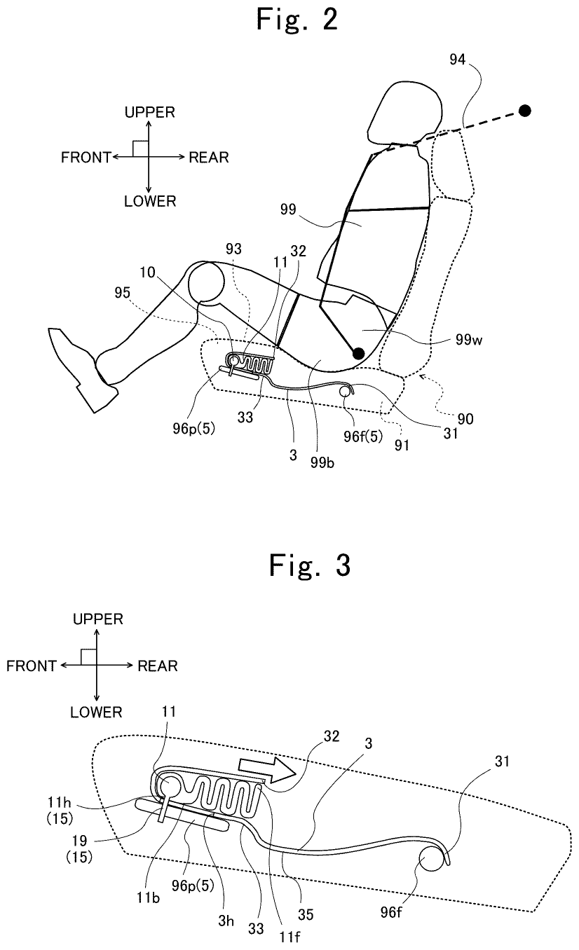

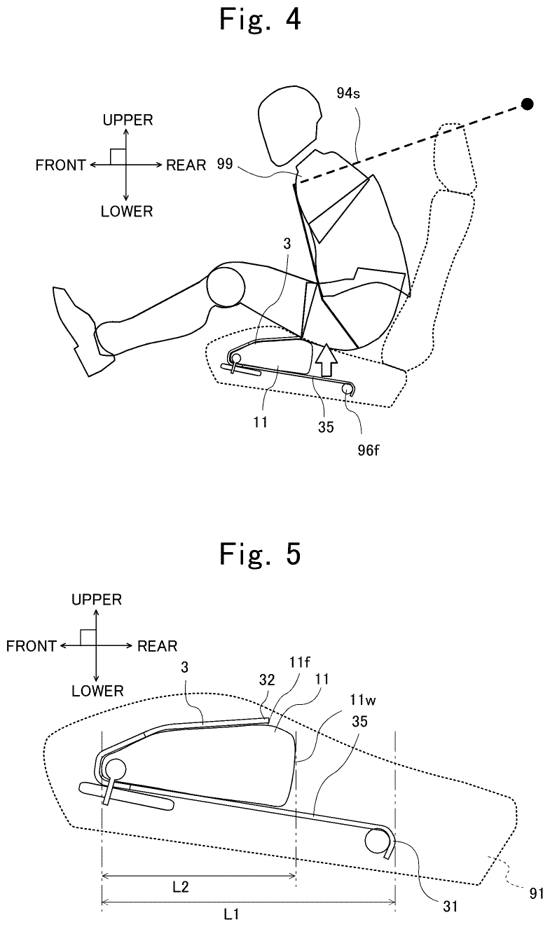

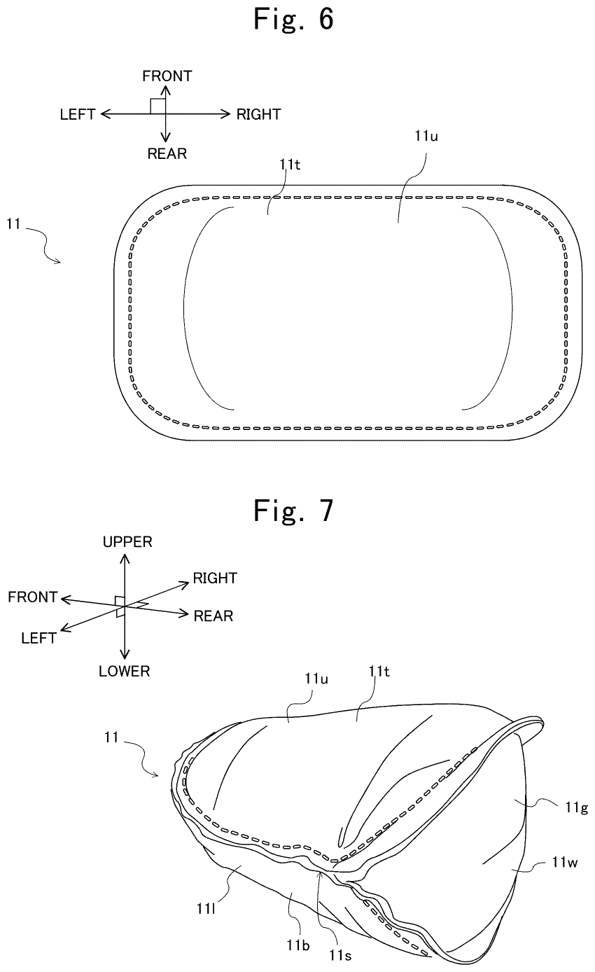

FIG. 1 to FIG. 7 schematically illustrate the seat cushion airbag structure of Example 1. FIG. 1 schematically illustrates the seat cushion airbag structure of Example 1 as viewed from the upper side. FIG. 2 illustrates the seat cushion airbag structure of Example 1 in a normal state. FIG. 3 is an enlarged view of a main portion in FIG. 2. FIG. 4 illustrates the seat cushion airbag structure of Example 1 during expansion and inflation. FIG. 5 is an enlarged view of a main portion in FIG. 4. FIG. 6 schematically illustrates an airbag in a normal state as viewed from the upper side. FIG. 7 is a perspective view schematically illustrating the expanded and inflated airbag.

Hereinafter, the upper, the lower, the left, the right, the front, and the rear in Example 1 refer to the upper, the lower, the left, the right, the front, and the rear in each of the drawings. The left-right direction coincides with the width direction.

A seat cushion airbag structure 100 of Example 1 includes a seat cushion airbag device 1 and a seat support portion 5.

As illustrated in FIG. 1, the seat cushion airbag device 1 includes an airbag 11 and an inflation fluid generation source 10.

In the seat cushion airbag structure 100 of Example 1, the seat cushion airbag device 1 is mounted to a seat 90 for a vehicle, and is more specifically disposed below a seat surface 93 in a seat portion 91 of the seat 90. In the seat cushion airbag structure 100 of Example 1, the seat cushion airbag device 1 is also considered to be disposed below the seat surface 93 in the seat portion 91.

Inside the seat portion 91, a seat pan 96p and a seat bar 96f are disposed as the seat support portion 5. The seat pan 96p is fixed to a not-illustrated seat frame at the front end portion of the seat portion 91. The seat frame constitutes a lower side portion in the seat portion 91 of the seat 90, is disposed below a cushion 95, and has a function of supporting the entirety of the seat portion 91 including the cushion 95.

The not-illustrated seat frame has two side frames separated from each other in the width direction, and a front frame which is disposed on the front side and connects between the two side frames.

The seat pan 96p is extended on the front frame and front side portions of the two side frames in the seat frame.

The seat bar 96f is extended on the two side frames in the rear of the seat pan 96p.

The airbag 11 is disposed above the seat pan 96p and the seat bar 96f inside the seat portion 91. The airbag 11 is considered to be disposed in a front side region between the center portion and the front end portion of the seat portion 91 in the front-rear direction.

The inflation fluid generation source 10 is disposed inside the airbag 11, and is fixed to the seat pan 96p by an attachment tool 19 described below in front of the seat bar 96f.

The inflation fluid generation source 10 of the seat cushion airbag device 1 is an inflator for generating gas as an inflation fluid, is connected to a not-illustrated control unit for expanding and inflating the airbag 11, and operates in response to supply of electric power. The control unit is an electronic control unit (ECU) of a vehicle.

The airbag 11 is formed of polyester woven fabric. As illustrated in FIG. 2 to FIG. 4, the airbag 11 has a bag-like shape, and is folded in a normal state as illustrated in FIG. 2.

As illustrated in FIG. 6 and FIG. 7, the airbag 11 has a tapered pillar-like shape obtained by sewing an upper fabric 11u, a lower fabric 111, and a gore fabric 11g. The upper fabric 11u and the lower fabric 111 have almost the same shape, and are continuously sewn at the left side, the front side, and the right side. The upper fabric 11u and the lower fabric 111 are not sewn to each other at the rear side, and the gore fabric 11g is inserted between the upper fabric 11u and the lower fabric 111 at the rear side. The rear side of the upper fabric 11u and the upper side of the gore fabric 11g are sewn, and the rear side of the lower fabric 111 and the lower side of the gore fabric 11g are sewn, to form the airbag 11.

The upper fabric 11u forms a top portion lit of the airbag, and the lower fabric 111 forms a bottom portion 11b of the airbag. A side portion his of the airbag is formed between the upper fabric 11u and the lower fabric 111.

As described above, the gore fabric 11g is inserted between the upper fabric 11u and the lower fabric 111 at the rear side. Therefore, when an inflation fluid generated by the inflation fluid generation source 10 is supplied into the airbag in order to expand and inflate the airbag as illustrated in FIG. 5, a standing wall 11w extending in the up-down direction is formed in the rear side region in the side portion 11s of the airbag by the gore fabric 11g.

The inflation fluid generation source 10 is disposed inside the airbag. The inflation fluid generation source 10 is fixed to the seat pan 96p by the attachment tool 19 having a bolt-like shape. A through hole 11h is formed at a position corresponding to the attachment tool 19 in the bottom portion 11b of the airbag, and the attachment tool 19 is inserted through the through hole 11h from the inside of the airbag 11 to the outside, and is fixed to the seat pan 96p. Therefore, in the seat cushion airbag device 1 of Example 1, an airbag attachment portion 15 is formed by the attachment tool 19 and the through hole 11h.

In the seat cushion airbag device 1 of Example 1, the standing wall 11w is disposed in the center region that is the center portion of three portions into which the seat portion 91 of the seat 90 is equally divided in the front-rear direction.

In the seat cushion airbag structure 100 of Example 1, the expanding and inflating direction of the airbag 11 is the rearward direction.

For reference, in the seat cushion airbag structure 100 of Example 1, the length of the airbag 11 in the front-rear direction is about 200 mm, and the length of the airbag 11 in the width direction is about 400 mm.

A tether portion 3 is formed of polyester woven fabric that is the same as the material of the airbag 11, and has a band-like shape. The tether portion 3 has a rear side attachment portion 31 at one end portion in the longitudinal direction, and has a front side attachment portion 32 at the other end portion in the longitudinal direction.

The rear side attachment portion 31 is fixed to the seat bar 96f below the airbag 11, and the front side attachment portion 32 is fixed to the front end portion of the top portion lit on the upper side of the airbag 11.

The rear side attachment portion 31 and the front side attachment portion 32 are disposed on the rear side relative to the airbag 11, that is, on the front side in the expanding and inflating direction.

In the tether portion 3, a connection portion 33 between the rear side attachment portion 31 and the front side attachment portion 32 has a long hole 3h penetrating through the tether portion 3 in the thickness direction and extending in the longitudinal direction. The attachment tool 19 is inserted through the long hole 3h, and both the tether portion 3 and the airbag 11 are fixed to the seat pan 96p. In other words, the airbag attachment portion 15 of the airbag 11 is fixed through the long hole 3h of the tether portion 3 to the seat pan 96p as the seat support portion 5.

The airbag 11 is inserted into the tether portion 3 between the upper side and the lower side of the tether portion 3 with the connection portion 33 having the long hole 3h being a boundary.

In the seat cushion airbag device 1 of Example 1, a part of the connection portion 33 and a portion closer to the rear side attachment portion 31 than the connection portion 33 in the tether portion 3 form a lower side support portion 35 disposed below the airbag 11.

In the seat cushion airbag structure 100 of Example 1, an expansion and inflation length L1 of the lower side support portion 35 in the tether portion 3 is about four-thirds of a length L2 of the airbag 11 in the expanding and inflating direction. The length of the tether portion 3 in the width direction is about 90% of the length of the seat portion 91 in the width direction.

The direction in which the warp thread extends in the tether portion 3 almost coincides with the front-rear direction. Therefore, an angle between the direction in which the tether portion 3 is pulled when the airbag 11 expands and inflates, and the direction in which the warp thread extends in the tether portion 3 is almost 0°.

In the seat cushion airbag structure 100 of Example 1, the tether portion 3 has a band-like shape extending in the width direction and the front-rear direction as illustrated in FIG. 1, and tension is applied to the tether portion 3 by expansion and inflation of the airbag 11.

More specifically, a distance in routing between the airbag attachment portion 15 and the front side attachment portion 32, that is, an actual length from a portion closest to the airbag attachment portion 15 to the front side attachment portion 32 in the tether portion 3 is increased during expansion and inflation as compared with the distance in a normal state. That is, at this time, the tether portion 3 is pulled toward the front side attachment portion 32, and thus, tension is applied to the tether portion 3.

As illustrated in FIG. 2 to FIG. 4, the lower side support portion 35 of the tether portion 3 is disposed below the airbag 11.

Therefore, the tether portion 3 efficiently supports the airbag 11 stably from the lower side when the airbag 11 expands and inflates.

Thus, the seat cushion airbag structure 100 of Example 1 allows the airbag 11 to expand and inflate up to a high position when an impact occurs, lifts a buttock 99b of an occupant 99 to a sufficiently high position from the lower side, and consequently moves sufficiently upward a waist portion 99w of the occupant 99 and allows the occupant 99 to be stably restrained and supported by a seat belt 94s.

The tether portion 3 is formed of fabric, and is bendable and deformable. Therefore, when the occupant 99 is seated on the seat 90, and the seat surface 93 of the seat 90 is deformed downward, the tether portion 3 disposed below the seat surface 93 in the seat 90 bends and deforms downward according to the downward deformation of the seat surface 93. In other words, at this time, the tether portion 3 bends and deforms downward along the buttock 99b of the occupant 99. Therefore, the tether portion 3 inhibits the seat 90 from degrading the cushioning property, and allows the seat 90 to maintain good seating comfort.

The seat cushion airbag structure 100 of Example 1 stably supports the airbag 11 during expansion and inflation by the above-described cooperation, so that the occupant 99 is stably restrained and supported by the seat belt 94s when an impact occurs. In addition, the seat cushion airbag structure 100 of Example 1 allows the seat 90 to maintain good seating comfort.

Furthermore, in the seat cushion airbag structure 100 of Example 1, the standing wall 11w extending in the up-down direction is formed at the rear side portion of the airbag 11 when the airbag 11 expands and inflates. Thus, the airbag 11 is greatly raised upward, in particular, on the rear side.

The standing wall 11w is disposed near the ischium of the occupant 99. Therefore, the seat cushion airbag structure 100 of Example 1 more sufficiently lifts the buttock 99b of the occupant 99 stably when an impact occurs, and consequently more sufficiently moves upward the waist portion 99w of the occupant 99 stably and allows the occupant 99 to be more stably restrained and supported by the seat belt 94s.

### Example 2

The seat cushion airbag structure 100 of Example 2 is almost the same as the seat cushion airbag structure 100 of Example 1 except for the expanding and inflating direction of the airbag 11 and a positional relationship between the airbag 11 and the tether portion 3.

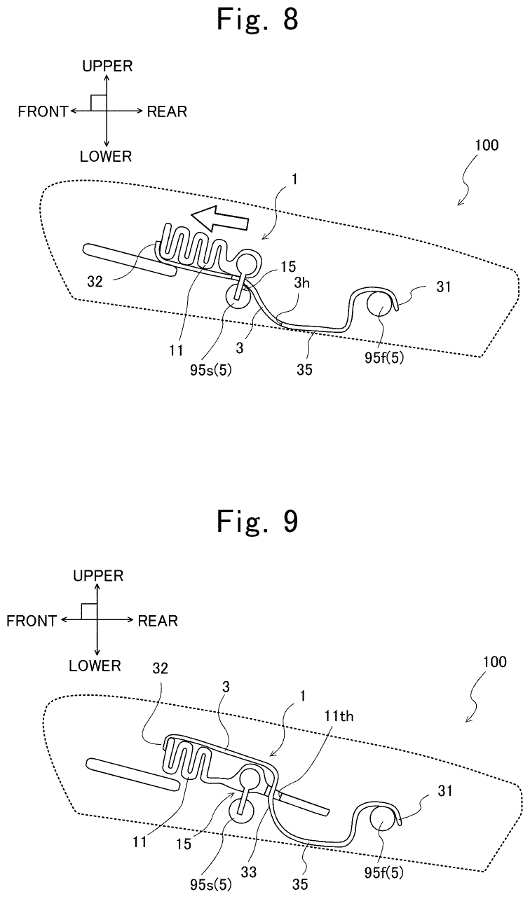

FIG. 8 schematically illustrates the seat cushion airbag structure 100 of Example 2.

The seat cushion airbag structure 100 of Example 2 will be described below by focusing on differences from Example 1.

As illustrated in FIG. 8, the seat cushion airbag structure 100 of Example 2 has two seat bars as the seat support portion 5. A seat bar 95s that is one of the two seat bars is disposed forward of a seat bar 95f that is the other of the two seat bars. The airbag 11 is fixed to the seat bar 95s at the airbag attachment portion 15, and expands and inflates forward.

The rear side attachment portion 31 of the tether portion 3 is fixed to the seat bar 95f below the airbag 11, and the front side attachment portion 32 is fixed to the front end portion on the lower side of the airbag 11. The front side attachment portion 32 is disposed forward of the airbag 11, that is, at the front side in the expanding and inflating direction. The rear side attachment portion 31 is disposed rearward of the airbag 11, that is, at the rear side in the expanding and inflating direction.

Therefore, in the seat cushion airbag device 1 of Example 2, the entirety of the tether portion 3 forms the lower side support portion 35 disposed below the airbag 11.

Also in the seat cushion airbag structure 100 of Example 2, similarly to the seat cushion airbag structure 100 of Example 1, the lower side support portion 35 of the tether portion 3 is disposed below the airbag 11, and tension is applied to the tether portion 3 by expansion and inflation of the airbag 11.

Therefore, also in the seat cushion airbag structure 100 of Example 2, the tether portion 3 efficiently supports the airbag 11 stably from the lower side when the airbag 11 expands and inflates.

Thus, the seat cushion airbag structure 100 of Example 2 allows the airbag 11 to expand and inflate up to a high position when an impact occurs, lifts the buttock 99b of the occupant 99 to a sufficiently high position from the lower side, and consequently moves sufficiently upward the waist portion 99w of the occupant 99 and allows the occupant 99 to be stably restrained and supported by the seat belt 94s, similarly to the seat cushion airbag structure 100 of Example 1.

### Example 3

The seat cushion airbag structure 100 of Example 3 is almost the same as the seat cushion airbag structure 100 of Example 2 except for the shape of the airbag 11, the shape of the tether portion 3, and a positional relationship between the airbag 11 and the tether portion 3.

FIG. 9 schematically illustrates the seat cushion airbag structure 100 of Example 3.

The seat cushion airbag structure 100 of Example 3 will be described below by focusing on differences from Example 2.

As illustrated in FIG. 9, in the seat cushion airbag structure 100 of Example 3, the airbag 11 has a through hole 11th penetrating from an outer surface on the upper side to an outer surface on the lower side. The connection portion 33 of the tether portion 3 is inserted through the through hole 11th of the airbag 11.

The rear side attachment portion 31 of the tether portion 3 is fixed to the seat bar 95f below the airbag 11, and the front side attachment portion 32 is fixed to the front end portion on the upper side of the airbag 11.

In the seat cushion airbag device 1 of Example 3, the rear side portion of the tether portion 3 forms the lower side support portion 35 disposed below the airbag 11.

Also in the seat cushion airbag structure 100 of Example 3, similarly to the seat cushion airbag structure 100 of Example 1 and the seat cushion airbag structure 100 of Example 2, the lower side support portion 35 of the tether portion 3 is disposed below the airbag 11, and tension is applied to the tether portion 3 by expansion and inflation of the airbag 11.

Therefore, also in the seat cushion airbag structure 100 of Example 3, the tether portion 3 efficiently supports the airbag 11 stably from the lower side when the airbag 11 expands and inflates.

Thus, the seat cushion airbag structure 100 of Example 3 allows the airbag 11 to expand and inflate up to a high position when an impact occurs, lifts the buttock 99b of the occupant 99 to a sufficiently high position from the lower side, and consequently moves sufficiently upward the waist portion 99w of the occupant 99 and allows the occupant 99 to be stably restrained and supported by the seat belt 94s, similarly to the seat cushion airbag structure 100 of Example 1 and the seat cushion airbag structure 100 of Example 2.

Although the present disclosure has been described above, the present disclosure is not limited to the above-described embodiments and the like, components described in the embodiments and the like may be extracted and combined as appropriate to carry out the present disclosure, and various modifications may be made without departing from the gist of the present disclosure.

In addition, the specification of the present disclosure discloses not only the technical concept according to the citation relationship of the claims as originally filed, but also the technical concept obtained by combining the matters recited in the claims as appropriate.

1. A seat cushion airbag structure comprising:
a seat support portion disposed below a seat surface in a seat of a vehicle;
a seat cushion airbag disposed below the seat surface and above the seat support portion, the seat cushion airbag attached to the seat support portion at an airbag attachment portion, the seat cushion airbag expanding and inflating when an impact occurs in the vehicle; and
a tether portion formed of fabric, the tether portion having a rear side attachment portion disposed on one end side in a longitudinal direction and a front side attachment portion disposed on another end side in the longitudinal direction, at least a part of the tether portion forming a lower side support portion disposed below the seat cushion airbag, wherein
the tether portion is
fixed to the seat support portion by the rear side attachment portion, and
fixed to a front side portion disposed at a front side of the seat cushion airbag in an expanding and inflating direction, by the front side attachment portion,
a connection portion between the rear side attachment portion and the front side attachment portion is attached to the seat support portion and the seat cushion airbag so as to pass through the airbag attachment portion, and
a distance in routing between the airbag attachment portion and the front side attachment portion is increased during expansion and inflation in which the seat cushion airbag expands and inflates as compared with a distance in a normal state in which the seat cushion airbag does not expand, and the tether portion is pulled toward the front side attachment portion.

2. A seat cushion airbag device comprising:
a seat cushion airbag disposed below a seat surface in a seat of a vehicle and above a seat support portion for the seat, the seat cushion airbag attached to the seat support portion at an airbag attachment portion, the seat cushion airbag expanding and inflating when an impact occurs in the vehicle; and
a tether portion formed of fabric, the tether portion having a rear side attachment portion disposed on one end side in a longitudinal direction and a front side attachment portion disposed on another end side in the longitudinal direction, at least a part of the tether portion forming a lower side support portion disposed below the seat cushion airbag, wherein
the tether portion is
fixed to the seat support portion by the rear side attachment portion, and
fixed to a front side portion disposed at a front side of the seat cushion airbag in an expanding and inflating direction, by the front side attachment portion,
a connection portion between the rear side attachment portion and the front side attachment portion is attached to the seat support portion and the seat cushion airbag so as to pass through the airbag attachment portion, and
a distance in routing between the airbag attachment portion and the front side attachment portion is increased during expansion and inflation in which the seat cushion airbag expands and inflates as compared with a distance in a normal state in which the seat cushion airbag does not expand, and the tether portion is pulled toward the front side attachment portion.

3. The seat cushion airbag device according to claim 2, wherein the seat cushion airbag has a standing wall extending in an up-down direction in a rear side region in a side portion disposed between a top portion and a bottom portion during at least the expansion and inflation.

4. The seat cushion airbag device according to claim 3, wherein the standing wall is disposed in a center region that is a center portion of three portions into which a seat portion of the seat on which an occupant is seated is equally divided in a front-rear direction.

5. The seat cushion airbag device according to claim 2, wherein
the connection portion in the tether portion has a long hole penetrating in a thickness direction and extending in the longitudinal direction, and
the airbag attachment portion is fixed to the seat support portion through the long hole.

6. The seat cushion airbag device according to claim 2, wherein
the seat cushion airbag has a through hole penetrating from one of outer surfaces toward another of the outer surfaces, and
the connection portion of the tether portion is inserted through the through hole.

7. The seat cushion airbag device according to claim 2, wherein
the rear side attachment portion is fixed to the seat support portion at a front side in the expanding and inflating direction below the seat cushion airbag,
the front side attachment portion is fixed to the front side portion of the seat cushion airbag on an upper side of the seat cushion airbag at a front side in the expanding and inflating direction, and
the seat cushion airbag is inserted into the tether portion between an upper side and a lower side of the tether portion with the connection portion being a boundary, so as to be sandwiched therebetween.
